(19) United States
(12) Patent Application Publication
(10) Pub. No.: US 2007/0292006 A1
(43) Pub. Date: Dec. 20, 2007

(54) Fingerprint compiler program of explanation

(76) Inventor: Alice Ann Johnson, Los Angeles, CA (US)

Correspondence Address: ALICE A. JOHNSON;A.J. COMPUTER PRODUCTS, 8710 BELFORD AVE., UNIT B 106, LOS ANGELES, CA, 90045, US

(21) Appl. No.: 11/651,933

(22) Filed: Jan. 8, 2007

Related U.S. Application Data
(63) Continuation-in-part of application No. 29/058,083, filed on Aug. 7, 1996, now Pat. No. D415737.
(63) Continuation-in-part of application No. 29/093,847, filed on Mar. 30, 1998, now Pat. No. D419972.

(51) Int. Cl. G06K 9/00

(52) U.S. Cl. 382/124; 705/44

(57) ABSTRACT

Present invention is an electronic fingerprint operable computer having a compiler memory compiled in soft and hardware programs and supporting elements, including a structured network allowing communication, and exchanging of data as necessary to the specific function of the connection, which is authenticating a fingerprint, and retrieving all information associated with a fingerprint and loops back the findings to the sending Fingerprint retrieval system, alerting the consumer to either abort or accept a transaction, systems introduced here are designed for consumers and financial institution such as banks, Service Stations, personal computers, any and all business that rely heavy on plastic credit cards and licenses to stop crimes, one in particular Identity Theft, the fingerprint retrieval unit by design has an incorporated peripheral allowing a GUI for the user to easily communicate and use, these products solve a lot of problems in the industries such as banks, Credit Card Airports (fraud, lost or stolen purses keys, passbooks, automobile have unlimited purposes, and like in most computer based products they can be tailored in size, memory, case coloring, and networking capabilities to fit the needs of the consumers, when the micro products introduced here reach peak in the USA, Americans will have all their assets in their finger.

### FINGERPRINT COMPILER PROGRAM OF EXPLANATION

Fingerprint Start Transaction Basic Function, (not Limited to)

The type of transaction is selected the amount of the transaction is entered If a fingerprint housing has been loaded with disk of the fingerprint then Scan the Fingerprint determining the minuet points The customer authorization code is entered The appropriate transaction is prepared The bank is called through a modem to a predetermined service (this may be different from current credit card validation services) else The Credit Card Number is entered The appropriate transaction is prepared The bank is called through a modem to the credit card validation service.

**The above checking allows both standard and fingerprint credit checks to be performed.**

Transmission to/from the Bank's Service

The Bank's computers retrieve the Customer Information based on the Credit Card or minuet points. The Account Demographics/Authorization Code are verified The Availability of requested funds to complete the transaction is verified. The Bank's computer transmits a transaction with the appropriate approval/rejection code.

Completion of the Transaction

If the return code from the Bank indicates NO funds were available (or other error code) then the appropriate error message is displayed on the unit the transaction is terminated.

At this point the transaction was approved by the bank, therefore A Receipt is printed A Record of the transaction is recorded in a Bubble Chip (These records provide periodic transaction summary information) the transaction.

### BACKGROUND OF THE INVENTION

### Field of the Invention

This invention relates to an AFIS (automated fingerprint identification and Database systems) designed in Computer Science, Electronics, and Network Communications, World Wide Web, internet graphical data operations, and the proven art of fingerprint detection. This newly designed invention adheres a strict Algorithm and protocol to run programs compiled in both software and machine Language to perform a sequential order of operations, when taken in when taken in Combination delivers a strong input to our National security utilizing an individual Fingerprint operating a micro fingerprint detector program that deploys a complete Cycle when an individual places his/her fingerprint in located in center of the electronic disk fingerprint becomes a signal start means to the systems CPU, to execute the programs function all the way to a load, lock and output of coded fingerprint, utilizing networking communication means to obtain a positive identification of an individual, the transmission of the sent fingerprint from the retrieval unit is an input signal to its interacting fingerprint verification database the CPU uses compiler programs of both Software and machine language in an order of sequential operations to obtain a positive identification of an individual fingerprints and additionally retrieve all pertinent Data associated with the sent fingerprint, execute a load, lock transmission back to the sending fingerprint retrieval system the answer that appears in the digital screen top of the fingerprint detector retrieval housing, when the small business, bank or large business reads the screen he knows to either accept the transaction or void

This invention is designed in a plug N play sub-assembled packages whereby a conversion on an existing database system is an elementary task. This design in computer technology along with modem/wireless communication technology adds a phenomenal convenience to financial institution, law enforcement and most particular credit card bank, databases and other industries using plastic cards for positive identification, to obtain cash money, goods, and other products such as gasoline, airline purchases, and departure. This micro system can be carried in a jacket or shirt pocket to maintain security at exit points whereby in the later the fingerprint detection system contents of fingerprints can be uploaded in banks pertinent records files for recall in the later, if an agency such as law enforcement or a conglomerate company wanted to revisit the collection of prints from certain date, time and place, give a copy, or place a purchasing price for retrieval. This invention overcomes disadvantages presently plaguing the open market and the consumers which is “identity theft” Static's show identity theft America's latest and climbing to first place on the list of crimes, the present invention was originally conceived with credit cards in mind, however, it should be understood that the products disclosed herein can be utilized in other allied fields, such as, revolving department stores, law enforcement patrol cars, banks, computers Airport for all check points and other establishments where plastic cards, punch cards, keys are utilized only the owner will have access to their belongings Heretofore, fingerprint utilization was reserved for law enforcement only, rendering system design relatively expense in manufacturing cost, bulky equipment special technology in servicing, and maintenance, as law enforcement required ink, heavy plating, rollers, teletype interacting primitive technology, that worked, to locate an individuals fingerprint along with an extensive waiting period for identification and pertinent data forwarded back to the sending agency, unless there had been a crime committed and law enforcement would may get it faster, we do know by utilizing these means of retrieval, law enforcement also had an extensive 72 hours holding time so all requested information would be in before dismissing an individual, or booking, additionally this technology was available only to law enforcement Present invention respects primitive invention is oppose to primitive fingerprint detection this technology should be in place for US business owner's protection for there is no way now to know, with all the art the new age crooks know US business owners have no way without an unreasonable doubt if a credit card being processed is presented by an authorized owner, or a thief, due to the education thieves, know the art of changing identification, some of the many branches of business affected by identity theft is as follows passports, driver's licenses, credit cards, banks, gasoline pumps, revolving charges, piracy on internet purchases, and personal computers and/or the likes.

Law enforcement has always used this technology to look for a criminal or identify one these products that are introduced here are in the category of PREVENTION, we design this invention to prevent a crime and all that goes along with identify theft, calling credit card companies, Social Security, DMV, prevent the waiting time it takes to reestablish yourself once your world is toppled by the loss of your credentials. Present invention provides a service of not having to carry plastic credit cards, driver's license or other forms of ID that can be lost or stolen and used by fraudulent persons, utilizing these products only require an individual to have a finger with them as few Americans leave home without one. Present invention is designed for the consumers participating in fingerprint detection as additionally security, a consumer will choose which finger is logged in at databases such as: DMV; BANK; Credit Card Company long as you have that finger in tact, you will have access to all that support a fingerprint database The following two sentences are quoted: from Science of Fingerprint Book: From earlier times, fingerprinting, because of its peculiar adaptability to the field, has been associated in the lay mind with criminal identification to the detriment of the other useful phases of the science. However, the Civil File of the Identification latter category victims of major disasters may be quickly and positively identified if their fingerprints are on file, thus providing a humanitarian benefit not usually Division of the Federal Bureau of Investigation contains three times as many fingerprints as the Criminal File, these civil fingerprints are an invaluable aid in identifying amnesia victims, missing persons, and unknown deceased. In the associated with fingerprint records. With an individual finger, you are in control of all your valuables, and finances.

With all new products introduction into the marketplace goes, a little waiting period for Americans to get the just of the products, understand the upgrade of the security one example was the transformation from the typewriter to the word processor to the now popular use of desktop computers, computer technology was a slow process, however, today every American family small and large business, law enforcement US Government officials enjoys the beautiful art of computer technology. The targeted convenience of these new products is to delete plastic cards that can be changed and modified, promoting identity theft, while maintaining a constant insurance rate, while improving quality of transactions in the US for citizens.

### SUMMARY OF THE INVENTION

Therefore it is a primary feature and advantage to banks, hospital ER rooms, mom and pop stores, gasoline stations, mini marts, and many more institutions, stores along with, industries, introduction of the fingerprint detection retrieval unit and mating Fingerprint Interacting database verification system, to gather conversation one another to make a Dependable positive identification system, structured in the latest art of electronics, Computer science logic, and communication networking technology, designed in both Software compiler programs, along with machine language, and driven by an individuals Fingerprint as polarity means to fingerprint operable computer detection retrieval unit, and its mating interacting comparison verification database system, present invention provides not only, banks, revolving charge accts, Int'l Airports check points, other industries would embrace this present invention for convenience of this stand alone, VAC or VDC plug and play operable device, sub-assembled packages, pocket size, or larger for counter tops, (customer will decide) easily installed in an automobile, on a bank tellers window top, FIG. 1a shows fingerprint capturing sub-assemble out of, FIG. 1b, its disk housing, demonstrating, interfacing of circuit housing, further showing to the trained mind capabilities of interfacing ATM's machines, computers, food-markets checkout counter tops and or the likes, allowing direct communication to a database and instantly retrieve a positive ID of individuals making a transaction, after an insertion scan in the fingerprint detection retrieval system. researched data, statistics, along with a detailed investigation and daily news monitoring indicated identity theft/fraud the highest rising crime in the USA today, from lost or stolen credit cards, drivers license, reproduction of passports, that enhances illegal entrance into the USA of undesirables, electronic disk loaded with fingerprint start means to the fingerprint operable CPU retrieval System handshaking software and compiled programs, translated to functional machine operations, incorporating automatic transmission technology performing a repetitive order of operations in fingerprint detection will definitely place additionally security in the arenas where positive Identification is required for protection of valuables, finances, and life threading situations accidents, as this invention can be utilized in ambulances in route to an emergency room, for expediting patient's name, and list medications do's/don't, from a medical database created by patients desiring additional security, thereby giving hospital ER rooms heads up, and ready on standby to administer correct treatment of drugs needed without any guest work, the patient records would send an alarm when entering the ER rooms computer, followed by his medical data for retrieval, and would stay online until the ER transferred the records into a hospital database, for future retrieval of supporting information reserved patient records would send an alarm when entering the ER room of a patients file, thereby freeing up space for more incoming emergencies. Programs create a medical data base, on national safety listings free, giving extra protection in event of “God Forbid” an accident occur, patients blood type, allergies, blood pressure, diabetic, type etc., whereby an ambulance transmits finer print information directly to ER, upon receipt of data ER creates patient data to hospital records, this stops time Consuming searches for patient data. After the ER (emergency room) transfers incoming patient files to hospital database, the ER can continue working going to next patient

### FIGURE DRAWINGS EXPLANATION

FIG. 1 is front perspective view of an electronic fingerprint operable, soft and hardware programmed computer (CPU) system having interfaced modem, wireless network, storage devices, with all supporting elements arranged, and mounted on a micro-motherboard private housing, controlling a fingerprint detector, FIG. 1 shows fingerprint capturing circuit FIG. 1a, out of FIG. 1b, its disk housing, whereby when inserted into FIG. 1c becomes polarity, start means to designated CPU driver of all functional operations incorporated in present invention that selectively extracts minute points from the input fingerprint, Codes minute points firstly, loads and locks fingerprint, outputs signal to FIG. 1h, FIG. 1's mating interacting comparison database system (hereafter database system) for authentication, (further discussed in FIG. 1h) after all protocols have been met, FIG. 1h; database systems CPU sends_loopback answer to source sending FIG. 1, units top housing FIG. 1d, the display account information's digital print screen, advising either an accept or void transaction depending on fingerprint findings, all FIGS. 1a, 1b, 1c, 1d, are located in present invention housing, thereof.

FIG. 2 is an enlarged side view of FIG. 1c showing that portion of invention housing, designed as resident housing for the fingerprint capturing/operable disk, whereas a fingerprint loaded in the fingerprint disk housing, provides polarity start means, to inner housed CPU programs in sequential order of functional, operations, from beginning to end insofar as (AFIS) automatic fingerprint identification systems, that authenticates an individual fingerprint, the fingerprint capturing/operable disk housing, is located on right side, of present invention housing, thereof,

FIG. 3 is viewing bottom housing of fingerprint retrieval system, showing 1j distinguishable marked “bookkeeping storage Chip Housing”, means of storing data that can be retrieved for many purposes, if a client would need a record of transactions, this invention allows consumers to provide retrieval services for a retrieval fee or could provide it as a courtesy to a priority customer. (these products can be thought of as a credit card transaction for exception of card providing records, data contents from the “Bubble Storage Chip Housing can be retrieved, and downloaded into owners personal computer to transfer to his/her company's safe of records, database for future references, while freeing up space in the “bookkeeping chip housing” if or when called for a particular transaction connector, reserve power in, plug, modem/wireless housing, disk FIG. 1c, demonstrating, bottom polarity means of awaking “CPU”, also seen is VAC plug, the power switch, and room for reserved lines in future if needed, All of the aforementioned housings, are located on present invention housing, thereof,

FIG. 4 is showing both VAC and telephone connection input means located on top housing of present invention housing, thereof,

FIG. 5 is demonstrating input means for DSL, CABLE Modem, D-LINK (wireless) input, along with printer port interface, serial for printing receipts, and additional memory or drive interfaces, these input means are located on lower front housing of present invention housing, thereof,

### FINGERPRINT COMPILER PROGRAM EXPLANATION (OF ONE TYPE INDUSTRY USE) BANKS

Fingerprint Start Transaction Basic Function, (not Limited to)

The type of transaction is selected the amount of the transaction is entered If a fingerprint housing has been loaded with disk of the fingerprint then Scan the Fingerprint determining the minuet points The customer authorization code is entered The appropriate transaction is prepared The bank is called through a modem to a predetermined service (this may be different from current credit card validation services) else The Credit Card Number is entered The appropriate transaction is prepared The bank is called through a modem to the credit card validation service.

**The above checking allows both standard and fingerprint credit checks to be performed.**

Transmission to/from the Bank's Service

The Bank's computers retrieve the Customer Information based on the Credit Card or minuet points. The Account Demographics/Authorization Code are verified The Availability of requested funds to complete the transaction is verified. The Bank's computer transmits a transaction with the appropriate approval/rejection code.

Completion of the Transaction

If the return code from the Bank indicates NO funds were available (or other error code) then the appropriate error message is displayed on the unit the transaction is terminated.

At this point the transaction was approved by the bank, therefore A Receipt is printed A Record of the transaction is recorded in a Bubble Chip (These records provide periodic transaction summary information) the transaction.

### DESCRIPTION SPECIFICATIONS OF INVENTION

This is a CIP application reference U.S. Pat. No. 415,737, having application Ser. No. 29/058,083 and U.S. Pat. No. 419,972, having application Ser. No. 29/093,847

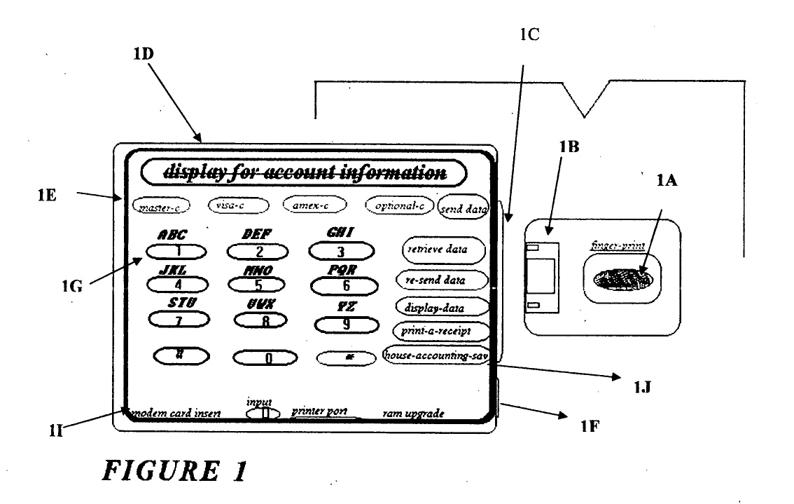

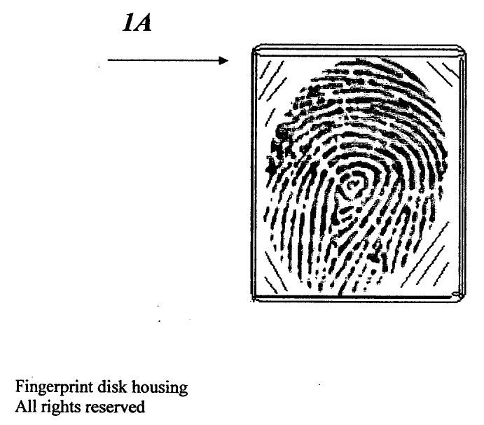

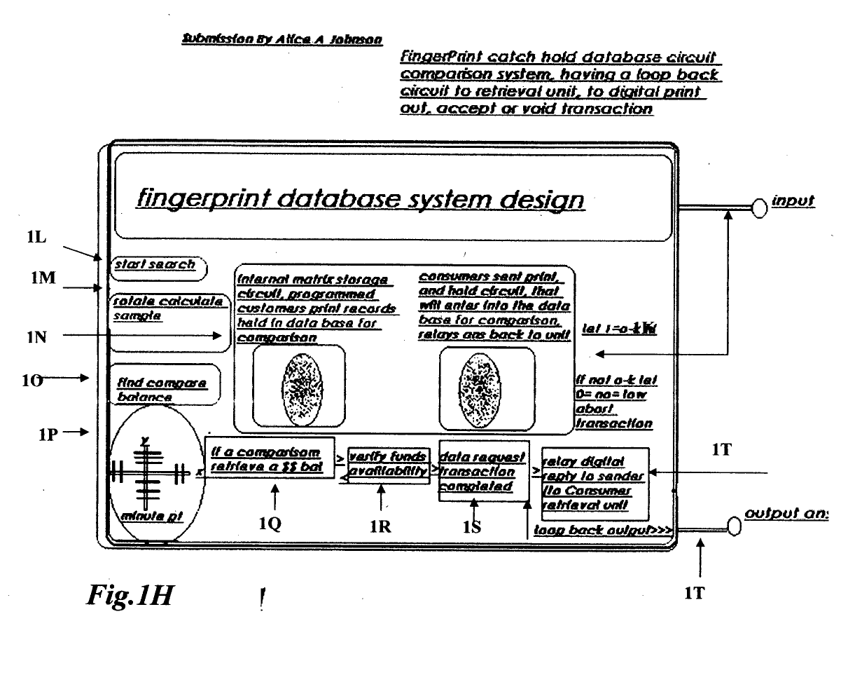

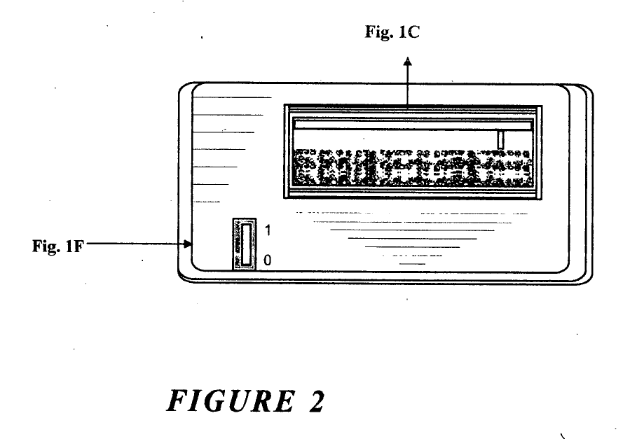

Referring now to FIGS. 1-1a-1b-1c-1d-1e-1f-1g and 1h, seen is FIG. 1 fingerprint detector retrieval unit and disk start means to a Computer (hereafter CPU), from beginning to end, having a programmed compiler burned to memory in strict protocol, that extracts FIG. 1a pertinent minute points of a fingerprint image, when a fingerprint is scanned/inserted in FIG. 1a, and FIG. 1a is seated in DISK FIG. 1b and seated in FIG. 2 housing, right side of present invention housing, the CPU of present Invention, FIG. 1, decodes extracted minute points of FIG. 1a, image, and fingerprint is coded in codes, are designed in a higher level language, that a computer understands, and can convert to audio pulse tones, or a bluetooth type network, etc., that will transmit converted fingerprint, over the network and directly inputs a signal into FIG. 1h, the mating interacting comparison verification, system this input signal activates the 2^{nd} CPU of present invention, designed to run still another program protocol that will accept the incoming print, load and lock the incoming fingerprint in FIG. 1j first holding circuit, where it remains until FIG. 1h, CPU executes a statement to scan FIG. 1k, Start search, the sent fingerprint locked in hold circuit, and if completed, go to a fetch cycle, rotate FIG. 1m functions, a particular registry until a match is found and seated in the adjacent, FIG. 1L hold circuit, and if a true match, CPU issues another statement to go to extensive search for additional data, if a balance retrieve all, balances, etc., if a comparison made, retrieve balances and prepare a loop back answer referring now to 1p,q,r,s, and t, wherall functional operations are distinguishably marked to the last output relay retrieval unit FIG. 1, as the loop back answer leaves 1h housing output it trips a good-bye to the 2^{nd} CPU, the CPU finishes up its FIG. 1h, housing by FIG. 1s where shown is the loop back answer to its mating fingerprint detector firstly clearing all registries, and placing the mating interacting database in a standby mode ready to process the next incoming signal to FIG. 1h, when the database system will once again run its its repetitive cycle of program steps in order of operations to deliver to the database system will once again run the consumers or financial institutions, or the likes, true identity of the individual standing in front of you attempting to make a purchase or do a transaction, FIG. 1 and FIG. 1h do repetitive cycles of operations, similar to the technology of a credit card however, it is highly unlikely you loose your finger products introduced here utilize the technology not looking for a criminal, to prevent criminal acts, in Functions, of fingerprint interacting mating database system FIG. 1h along with Fingerprint holding circuits are located in present invention FIG. 1h locations, and are not limited to credit databases listed here in present invention as choice of data base inserts is up to merchant that orders the machine, and is given the option at the time he orders the present invention for example Saks Fifth Avenue, Lord And Taylor might want to utilize the security feature for their private data base of established customers to save money on card renewals, mailings and other check purchases, still yet another feature of this invention is their mobile ability, insofar, as airports, bus stations, trains and cruises, each check in person can be given this unit as a pocket unit, when he breaks or leaves for lunch or the evening the unit will go with the security guard that checks it out in the mornings, and each security officer is resp9onsibile for their unit, this insures that all units stay accounted for or there are certain results applied, loosing a unit would be like a police loosing his/her gun, the aforementioned example was strictly for AIRPORTS, Incorporated bookkeeping chip provides owners more monetary control insofar As taxes, and pertinent data issues requested by Government, a customer or a Financial institution needing proof of transaction, and date,

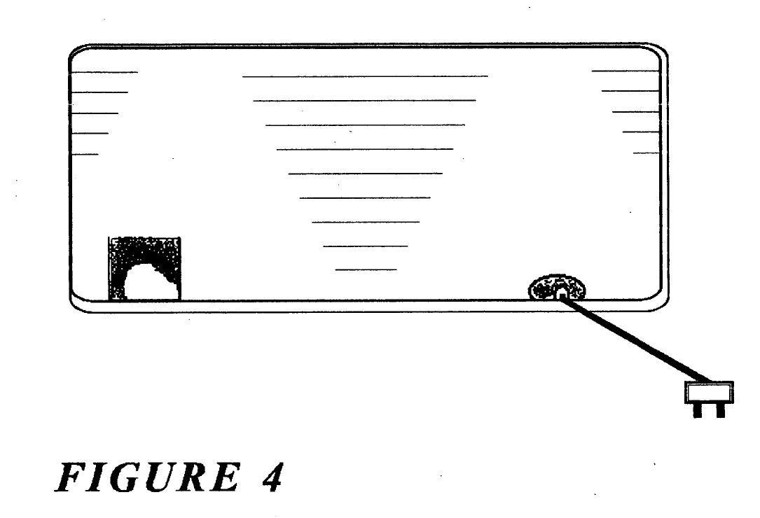

Additionally shown is service entrance for disk housing, peripheral connector, USB Power in, peripheral connector, communications/modem insert and an additional slot held In reserved service for an unforeseen device needed in the later, along with manual On/off switch, for trouble shooting manually, the said bookkeeping chip housing, disk Insert housing, input/output peripheral connector, USB power input, Communication/modem card insert housing, manual on/off switch housings are Distinguishale marked, and located on bottom of present invention housing, thereof FIG. 4. Is a back elevated view of the top of the fingerprint retrieval unit showing the VAC plug, is polarity to fingerprint retrieval unit, the VAC plug is located on the Lower right side, top of present invention housing, thereof,

Additionally shown is the input telephone connections housing, means of Connecting a telephone to the fingerprint retrieval unit, the telephone connection housing is located on the lower left side, top of present invention housing, thereof,

The fingerprint significant minute points will be Extracted, coded, so as each Individuals fingerprint a minute point signal value, and further, each minute point generating a signal in numerical value, where by each value generates a definite signal output value, in final said Fingerprint minute points are a series of computer pulsating signals, these signals are now output has been created, and said output signals are coded, input signals/pulses to a modem or the like device, where a conversion from computer Language is transformed into suitable transmission tones over a network or Communication facility utilizing audio pulse Intelligence, the fingerprint travels over the wires/network in the form of the said of the transaction, located on the right side, center housing, of present invention Additionally seen is a front elevation view of CPU's interfaced, interacting Distinguishable marked locations for additional components, modem card/or Other telecommunication means, such as USB input, printer port and ram Upgrades, labeled a plurality of input plug N play, components housings, are located on bottom, of FIG. 1, present invention housing, thereof,

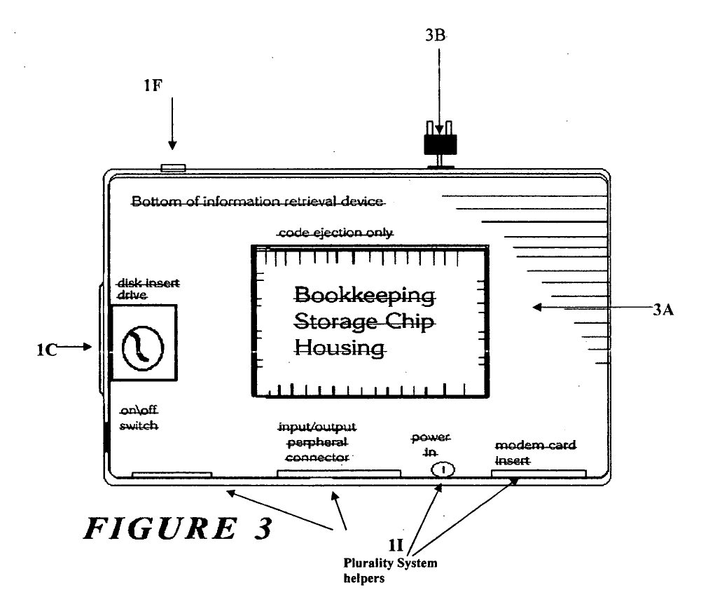

FIG. 3, is a very important feature of present invention, whereas the technology of the bubble chip is a hearty feature for both the consumer and the merchant, as it stores transactions of data, that should be downloaded regularly in order to keep a free amount of storage on the unit for retrieval in the later if needed by the consumer or the merchant a very important feature or one could tie a database storage to the unit the bubble storage chip is distinguishable marked on bottom of present invention housing, thereof

FIG. 2 is an enlarged portion of present invention, showing fingerprint Retrievals Disk housing, the housing affords a hardtop or a convertible, it would Be up to the consumers needs including the fingerprint carrying housing, Illustrating an insertion point, start-up means to CPU, having A mating configured circuit provides excitation when disk is inserted into Fingerprint disk housing, changes systems state to output signal, which inputs a Signal start means to CPU's order of operational programs, the fingerprint disk Housing is located on the right side center housing, of present invention, thereof, For troubleshooting etc., the manual operating power switch is represented by a (1),/(0) the manual switch is located on lower left bottom, right side, of Present invention housing, thereof.

FIG. 3 is a bottom view of the electronic fingerprint detector retrieval housing Viewing locations of a variety of embedded components, troubleshooting means Utilizes an access code, whereby inputting the access code, on front housing Peripheral, the bookkeeping housing compartment will automatically open, the fast paced world we live in, dictate that Americans maintain pace with the era we live in, regarding technology CPU micro-board, with all supporting elements, to insure order of operation, housing, located, in present invention housing thereof,

the data that just left housing 1h, loop back answer to fingerprint detector retrieval unit, the signal enters the top housing of the unit display for data digital print out, and storage, the storage is sent to bubble storage chip, which is stored for later retrieval and transport to the consumers private database for tax/accountant purposes etc., the bubble chip is located on the bottom of FIG. 1, in present invention housing thereof,

fingerprint/computer controlled detector retrieval system additionally incorporates a plurality of button distinguishable marked according to a Particular functions, seen are plurality of FIG. 1f's, which can be operated in a manual mode if necessary, retrieve data, send data, re-send data, display data, print a receipt house accountant button programmed in security code For merchants choice, and are labeled as a plurality of peripherals plug-N-play, Also seen is an incorporated peripheral consisting numerical and alpha keys, along with reserved keys for particular tie-lines, examples shown are Master-card, Visa-Card, Amex-card, and (1) optional line in reserved, along with a send-data, Retrieve data and, re-send lines, a display-data, print-a-receipt function, House-Accounting line for owner bookkeeping purposes further discussed in FIG. 3, it Should be noted while these products were designed with financial institutions In mind, these peripheral keys can be relabeled to accommodate other institutions, And industries lines, the incorporated peripheral is located under display window, On front center housing of present invention, housing, thereof,

FIG. 2 is disk housing, for present invention is entrance of FIG. 1a, start means to the CPU that drives the fingerprint retrieval unit from beginning to end of the transaction, located on the right side, center housing, of present invention Additionally seen is a front elevation view of CPU's interfaced, interacting Distinguishable marked locations for additional components, modem card/or Other telecommunication means, such as USB input, printer port and ram Upgrades, labeled a plurality of input plug N play, components housings, are located on bottom, of FIG. 1, present invention housing, thereof,

FIG. 3, is a very important feature of present invention, whereas the technology of the bubble chip is a hearty feature for both the consumer and the merchant, as it stores transactions of data, that should be downloaded regularly in order to keep a free amount of storage on the unit for retrieval in the later if needed by the consumer or the merchant a very important feature or one could tie a database storage to the unit the bubble storage chip is distinguishable marked on bottom of present invention housing, thereof

FIG. 2 is an enlarged portion of present invention, showing fingerprint Retrievals Disk housing, the housing affords a hardtop or a convertible, it would Be up to the consumers needs including the fingerprint carrying housing, Illustrating an insertion point, start-up means to CPU, having A mating configured circuit provides excitation when disk is inserted into Fingerprint disk housing, changes systems state to output signal, which inputs a Signal start means to CPU's order of operational programs, the fingerprint disk Housing is located on the right side center housing, of present invention, thereof, For troubleshooting etc., the manual operating power switch is represented by a (1),/(0) the manual switch is located on lower left bottom, right side, of Present invention housing, thereof.

FIG. 3 is a bottom view of the electronic fingerprint detector retrieval housing Viewing locations of a variety of embedded components, troubleshooting means Utilizes an access code, whereby inputting the access code, on front housing Peripheral, the bookkeeping housing compartment will automatically open, the Incorporated bookkeeping chip provides owners more monetary control insofar As taxes, and pertinent data issues requested by Government, a customer or a Financial institution needing proof of transaction, and date,

Additionally shown is service entrance for disk housing, peripheral connector, USB Power in, peripheral connector, communications/modem insert and an additional slot held In reserved service for an unforeseen device needed in the later, along with manual On/off switch, for trouble shooting manually, the said bookkeeping chip housing, disk Insert housing, input/output peripheral connector, USB power input, Communication/modem card insert housing, manual on/off switch housings are Distinguishale marked, and located on bottom of present invention housing, thereof

FIG. 4. Is a back elevated view of the top of the fingerprint retrieval unit showing the VAC plug, is polarity to fingerprint retrieval unit, the VAC plug is located on the Lower right side, top of present invention housing, thereof,

Additionally shown is the input telephone connections housing, means of Connecting a telephone to the fingerprint retrieval unit, the telephone connection housing is located on the lower left side, top of present invention housing, thereof,

The fingerprint significant minute points will be Extracted, coded, so as each Individuals fingerprint a minute point signal value, and further, each minute point generating a signal in numerical value, where by each value generates a definite signal output value, in final said Fingerprint minute points are a series of computer pulsating signals, these signals are now output has been created, and said output signals are coded, input signals/pulses to a modem or the like device, where a conversion from computer Language is transformed into suitable transmission tones over a network or Communication facility utilizing audio pulse Intelligence, the fingerprint travels over the wires/network in the form of the said Audio pulse tones or other transmission intelligence, to its mating interacting tones for travel or Communication facility utilizing audio pulse tones for travel or other transmission Fingerprint database, as the transmitted fingerprint enters the fingerprint database Housing, it passes through a companion modem or like device, the audio pulse tones or similar transmission Intelligence device, is changed back into its original format Understandable by a computer language to properly interact in conversation with the Companion fingerprint database system's computer, as the fingerprint exits out the Modem, the first bit out is the start means of the CPU's sequential order of operations, the sent fingerprint continues inside the Fingerprint database system to its destination of a holding mode housing Holding mode housing, (hereafter called holding housing) provided in the fingerprint Once completely loaded into the holding circuit housing, its completion, creates as stimulus, start means of the database's CPU to execute a search program for the seated Fingerprint once the fingerprint is identified in the database, the compiled CPU's order Of operations will further queue all data associated with the identified matching Op code signifying completion using a loop back configuration of completion, thereby, Directing the system to loopback signal to the source point, (the fingerprint retrieval unit) An answer back indicating acknowledgement answer to the original query at this stage of Operations, the information gathered passes back through the interactive conversational Database's modem or similar type communication device, again coded, and converted Into audio pulse tones or other transmission intelligence suitable for travel back to the Interacting fingerprint retrieval unit entering into the fingerprint units companion Modem or like device, converted back into understandable computer language logic, That the fingerprint retrieval unit modem or cellular device, converting the coded pulse Signals, back in computer language to the CPU whereby, the CPU issues a commanding Read/print statement to the “fingerprint retrieval's digital print out screen the answer to Its query in format readable to the human eye, thereby, alerting the sending institution or Business to either VOID or ACCEPT transaction. Meanwhile the output from the Interacting conversational database CPU continues its closing statements, signaling Release of the original fingerprint from the holding circuit housing, clearing the cache, all Registers along with all data associated with that particular sent fingerprint and switches The database off to a standby position, awaiting another fingerprints entrance, at which Time the database will once again do all of the aforementioned order of operations in its Repetitive preprogrammed cycles.

It should be noted while these products are designed with financial institutions in mind Where positive identification is a must or otherwise FRUAD, such as checks, credit Cards, passbooks, ATM machines, revolving charge accounts, and safety deposit Boxes Carry valuables and other forms of valuables, it should be understood that present Invention is not limited to one application of protection alone, other markets and Industries would profit by utilizing this product. One of the chief advantage is Sizing, and secondly the designed with the ability to interface, and or converse with Existing equipment, additionally while this fingerprint was designed with computer logic, it should be understood that an off the shelf fingerprint capturing program can be interfaced in present inventions

To mention a few, employee time clocks, high priority lavatories, Law enforcement in Patrol cars, gated communities for entrance, computer access, a fingerprint with these Products can be utilized to replace plastic cards, switches, and keys, as this micro system Design can be stepped up and or down depending on a particle application request. Identification and keys these products are not limited to that particular application. For Example if the products are utilized for approval of credit, the digital screen will Acknowledge either an acceptance or void transaction, on the other hand if the products Are used as a point of entry, in oppose to a key, the retrieval unit will acknowledge either By energizing the lock and changing its state of condition, or remain reenergized, the External mechanism that the retrieval unit is interfaced, or the tie points will activate Accordingly, the back top wall of the fingerprint retrieval system unit is the housing for VAC means for distributing a variety of VDC to the finger print retrieval system and Other supporting elements, forming an order of operations the fingerprint retrieval unit System conveniently seats comfortably on any bank counter.

Any gasoline pump, patrol cars, and desktops, while left side of housing is a plain wall Making housing structure enclosure, it can be looked at for reserved lines in the future, While the lower front wall accommodates, USB, Memory, Serial Port, Modem/communication, along with reserves for additional plug in sub-assembly Connections all located on present invention housing thereof,

Present invented products have been researched in the marketplace and to date no Products were found being utilized in the United States of America for the purpose of “Positive identification”, however, as we grow in the era of computer science, and IT Research has found that there is a high volume need for these products in the consumer Markets.

The targeted goal is to replace plastic cards, passbooks, and other forms of Identification that can be easily changed and or altered, to an upgraded use of fingerprint Detection, in step in our century of Computer Science and Networking technology, which Has been proven and utilized by law enforcement for many decades, will inevitability Prove without an unreasonable doubt an individual positive identification, while adding a new security feature that will add to and enhance Americans better quality lifestyle.

Referring now to FIG. 1, 1a, 1b, 1c, 1d, 1e,1f,1g, 1h, seen is FIG. 1 an “Electronic Fingerprint Operable Computer (hereafter CPU) “fingerprint retrieval system, shown with its disk FIG. 1a sub-assembled package out of its center housing, the disk exhibits the fingerprint housing located in center of said disk sub-assembled housing package, FIG. 1a, shows the fingerprint capturing circuit out of the fingerprint carrying disk housing, FIG. 1b disk sub-assembled package, media that is shown out of FIG. 1c, the disk housing, whereby a fingerprint aligned in or scanned over center of Fingerprint disk housing, an image of the fingerprint is captured; FIG. 1a, when the fingerprint is in FIG. 1a, seated in FIG. 1b, when seated in FIG. 1c, polarity/power is established, deeming the inserted fingerprint the “start” means to the “electronic fingerprint operable COMPUTER, (hereafter CPU), the CPU now awakened is the designated driver of present invention, the CPU executes a program in software, compiled in machine language, incorporates a strict protocol and custom algorithm that insures a lock.and, loading a fingerprint automated communication output over the network, as a direct input signal to its fingerprint comparison verification network interacting database system, #1 CPU, with all supporting elements take housing nested on a micro-motherboard located inside center housing, of electronic fingerprint operable computer retrieval system and disk, (hereafter fingerprint retrieval system), present Invention housing, thereof, further if a match is found, go to fetch data cycle, retrieve all data associated with that particular individual fingerprint, furthermore, when the order of operations has finished, the system is so designed to code a loop back return output signal from Interacting comparison database, back to sending fingerprint retrieval system, pertinent data on the transmitted fingerprint, in a digital Format, that appears in the top housing of FIG. 1 digital display screen housing located in present invention housing thereof,

The fingerprint carrying housing unit FIG. 1a. is located in center of disk housing; located in center of FIG. 1b, sub assembled disk housing, disk housing is the sub-assembled housing means of capture/holding, fingerprint during conversion process, located on right side, center housing, that seats into the disk housing, and the disk housing seats into the disk drive housing, located, in right side center of present Invention housing, thereof,

FIG.-1 additionally shows alpha numerical keys in center front, in the event Manual intervention is needed, these alpha numeric keys in present a networking signal transmission of an individual “fingerprint” in a Functional sequential order of operations, written in a higher level language, by a programmer, compiled, in a sequence of corresponding machine Language, “outputing” the fingerprint via networking transmission signals which travel directly into “Input” housing of the 2^{nd} CPU controlled mating “Interacting” Automatic, Fingerprint Comparison Verification Network DATABASE” System, as signal enters the database system, it wakes the CPU, thereby rendering CPU the designated driver of the interacting database comparison verification Database, it executes a statement to seat the sent fingerprint to the 1^{st} hold housing circuit for comparison and verification when a match is found, the CPU executes an instruction for compared fingerprint be seated in 2^{nd} hold Circuit housing, the sent fingerprint and the retrieved fingerprint print are Now side by side as seen in FIG. 1h, interacting mating database system comparison verification database system, due to the factual designed structure, deems it to functions as one invention, in other words the Only human intervention occurred is when an individual fingerprint is Deposited on or into the fingerprint disk housing, shown in FIG. 1a, is Demonstrating the fingerprint circuit sub-assembled packaged housing, out Of its housing, at the center of disk housing. When the matched fingerprint Is in the 2^{nd} hold circuit, the CPU signals a fetch DMA (direct memory Access) data statement or additional information associated with the Fingerprint in “queue”, (such as account balance; medical record; criminal Record, or total employee hours in a pay period) these sub-assembled Packages work hand in hand in a sequential order of operations to form a fingerprint Operable detector retrieval system unit and disk, start means to FIG. 1, and whereby fingerprint output from FIG. 1, remains the same controlling fingerprint entering into FIG. 1h, deeming the said same fingerprint, operable interacting the mating fingerprint comparison verification database system as the individual fingerprint entered to start the identification, making present invention a fingerprint operable, computer controlled fingerprint detector, that America is ready to embrace, to curve identity thief in the USA markets today.

### FINGERPRINT COMPILER PROGRAM OF EXPLANATION

Fingerprint Start Transaction Basic Function, (not Limited to)

The type of transaction is selected the amount of the transaction is entered If a fingerprint housing has been loaded with disk of the fingerprint then Scan the Fingerprint determining the minuet points The customer authorization code is entered The appropriate transaction is prepared The bank is called through a modem to a predetermined service (this may be different from current credit card validation services) else The Credit Card Number is entered The appropriate transaction is prepared The bank is called through a modem to the credit card validation service.

**The above checking allows both standard and fingerprint credit checks to be performed.**

Transmission to/from the Bank's Service

The Bank's computers retrieve the Customer Information based on the Credit Card or minuet points. The Account Demographics/Authorization Code are verified The Availability of requested funds to complete the transaction is verified. The Bank's computer transmits a transaction with the appropriate approval/rejection code.

Completion of the Transaction

If the return code from the Bank indicates NO funds were available (or other error code) then the appropriate error message is displayed on the unit the transaction is terminated.

At this point the transaction was approved by the bank, therefore A Receipt is printed A Record of the transaction is recorded in a Bubble Chip (These records provide periodic transaction summary information) the transaction.

### SPECIFICATION DETAILED DESCRIPTION

FIG. 1 is front perspective view of an electronic fingerprint operable, computer programmed in art and guidelines of see FIG. 6, software template and its explanatory order of sequential operations, FIG. 1 additionally incorporates a compiler that adheres a strict protocol of programmed machine language, driven by a CPU and all supporting elements to insure authentication of a single fingerprint, retrieve additional data and generate an automatic answer that outputs in the merchants fingerprint detector 1D digital print screen and answer from the fingerprint advising a void or accept a transaction, the CPU is the designated driver of the system, the CPU, modem, wireless network, storage devices, with all all supporting elements take lodging on a micro mother board, located in present FIG. 1,

FIG. 1 shows fingerprint capturing circuit FIG. 1A, out of, its disk housing, 1B, when 1B is properly seated into 1C, housing, polarity, is established, to CPU the designated driver of all functional operations incorporated in present invention, programmed in sequential order of repetitive operations in selectively, capturing, extracting and coding minute points from a single input fingerprint, and further when protocols have been met, will additionally, load, lock, and automatically, transmit an output of the coded fingerprint in final, an audio pulsating signal or pulse tones designed to travel over telephone wires, or wireless communication means to the fingerprint detectors mating interacting comparison database system (hereafter database system) FIG. 1H for authentication, (further discussed in FIG. 1H whereby after protocols have been met FIG. 1H; database systems CPU sends a loopback answer over the network to the mating fingerprint detector, FIG. 1, the source sending fingerprint detector, that digitally inputs, 1D answer to data requested, FIG. 1 top housing display digital print screen, a message advising a merchant either accept or void transaction. depending fingerprint findings, also FIG. 1 displays 1E, a plurality of direct database buttons, distinguishable marked, along with a send data button, when send button is depressed, fingerprint query is sent to FIG. 1H, for authentication.

1G is a plurality of self explanatory peripheral input buttons, 1G is not limited to any particular peripheral functions, however, has many place holders are standard, 1I, display is a plurality of system helpers inputs, such as upgrades USB inputs/printer interface, conjunction with the manual alpha numeric keypad 1G,

FIGS. 1, and 1A its referenced alpha numbers, 1B,1C, 1D, 1E, 1F, 1G, 1I, and 1J, are located in front housing, of present invention housing, thereof,

FIG. 2 is an enlarged side view of FIG. 1 showing 1C the fingerprint disk Housing designed in capturing, a fingerprint and whereby insertion of a fingerprint insofar as (AFIS) automatic fingerprint identification systems goes, will authenticate an individual by loading a fingerprint in the fingerprint disk FIG. 1A housing, of present invention, and seating 1B disk in its 1C housing establishes a polarity and, start means, to inner housed CPU of programs written in a sequential order of functional, operations, that will identify an individual by his/her fingerprint, the disk housing, is located on right side, center of present invention housing, thereof,

FIG. 3 is viewing bottom housing of fingerprint retrieval system, showing the “Bubble Storage Chip Housing, distinguishable marked 3A, housing 3A is uniquetly designed to store transaction data in thumbnails, whereby the storage will give a warning when the chip is almost at its capacity thereby giving owner heads up to place files in corporate archives/safe of records, database for future references, while freeing up space in 3A “bookkeeping chip housing” if or when called for a particular transaction from a customer/client the records can be easily retrieved for customer courtesy from said archives. 1C, is demonstrating its, bottom, similar to an infinity sign, polarity, electrical start means to the driving CPU incorporated in FIG. 1, also seen is 3A bookkeeping housing, that provides storage for all fingerprints and manual transactions, 3B, a VAC power plug, 1I reserved lines for system helpers in additional upgrades that may be needed, FIG. 3, its reference number 3A, 3B, are located on present invention bottom housing, thereof

FIG. 4 is showing a portion of FIG. 3, specifically 3B, however, it additionally shows Communication connection housing, 4A telephone, line input housing means located on top housing of present invention housing, thereof,

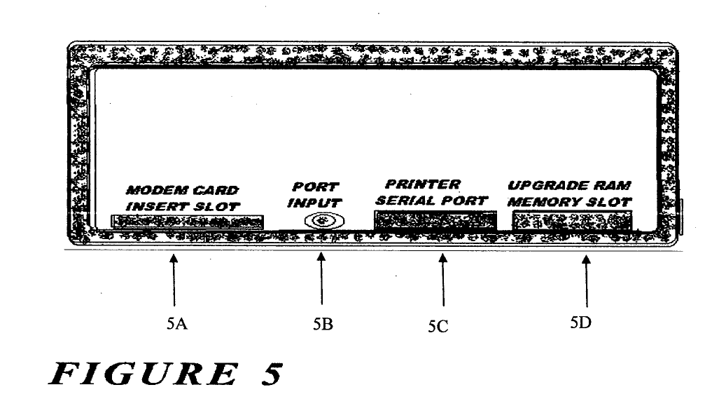

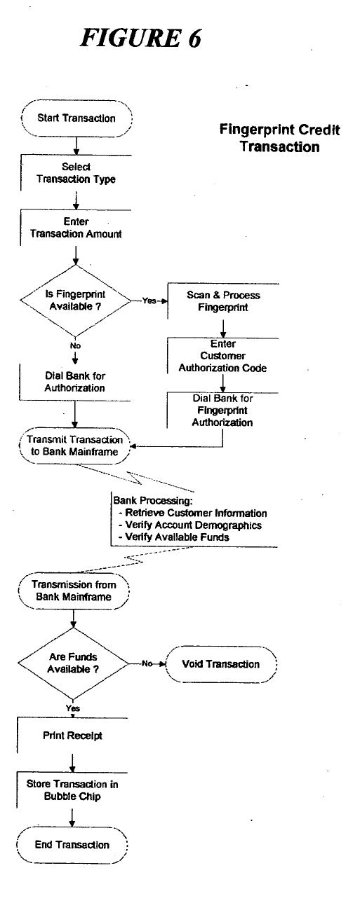

FIG. 5 is demonstrating input means for DSL, USB power, D-LINK (wireless) input, along with printer port interface, serial connection means for printing receipts, etc., shown as a plurality of system helpers and or enhancements FIG. 5 consists of reference numbers 5A,5B,5C, and 5D these input means are located on lower front housing of present invention housing, thereof,

FIG. 6 is a fingerprint credit transaction template showing, software program of Operational steps in a sequential order of operations, also the FINGERPRINT Compiler Program of explanation has been included for ease in understandings transaction of basic function (though not limited); transmission from bank, and transaction summary the following paragraphs summarize the order of functional operation, in imaging capturing and network communications, this invention functions in artificial intelligence a written program, configured for ease in maintenance, and designed in sub-assembled housing package, FIG. 1A, shows fingerprint capturing circuit out of the fingerprint carrying disk housing. 1B, disk sub-assembled package, shown out of 1C, its disk housing, when fingerprint is aligned/scanned in center of Fingerprint disk housing, an image of FIG. 1A is captured; when FIG. 1A, is in its 1B disk housing, and 1B disk, is in drive 1C disk housing, polarity, is established, and becomes “start” means to electronic fingerprint operable Retrievals Computer controlled, (hereafter CPU), fingerprint detector retrieval unit's CPU, now awakened, becomes the designated driver of present invention, the CPU executes statements that lock, codes, and automatically loads. FIG. 1A's captured fingerprint for an output transmission from FIG. 1 housing, transmits over the network, as a direct input to FIG. 1H, FIG. 1's mating, conversations' fingerprint comparison Verification network for authentication, and transaction approval on sent fingerprint. FIG. 1H is a home for several components, that support proper operations of the invention being introduced here, FIG. 1H is configure red in strict protocol and driven by a CPU, designed to interact, and converse with FIG. 1 database of recorded files in both small and large computer data files and records, whereas FIG. 1's output directly “inputs” FIG. 1H, further as fingerprint enters into reference node 1K, the designated CPU driver, is excited to a change state, start means to the database system, the CPU issues first statement in order of sequential operational protocol, whereby 1K, incoming fingerprint, is driven by CPU to its holding housing 1K shown on right side of FIG. 1H. when 1K is seated in holding circuit, the CPU signals 1L to change stage to a start search, retrieval cycle, pulsing 1M, to run its routine, rotate calculate and pull code from fingerprint sample circuit, seated in 1K housing, when fingerprint minute code has been extracted, 1M, signals 1N to a seated mode to the left of housing 1K, 1N remains, with minute code available for 1O to reference, as seating of 1N pulses 1O the database comparator circuit is activated, while in comparison, mode the comparator circuit performs an examination of fingerprint, and follows with a decision, if the fingerprint finding is less than or greater than the fingerprint circuit will activate a decision, 1P handshakes 1O in comparison calculations, and rendering a final decision back to FIG. 1, which inevitability has to either accept or void the transaction, if findings are equal to, the circuit will execute the statement output to accept the transaction when cycle is completed, or if the comparison renders a less than statement, the transaction will have to be voided this message is loaded for output which appears in FIG. 1 top housing digital display screen advising merchant either accept or void the transaction (It should be understood each fingerprint database consists of pre-logged customers fingerprints, and is created by and or from the financial Institutions, Industries, conglomerate, and or a government agency requesting the product, and products will be to spec on custom orders per request. Product being introduced, are designed in modern technology, insuring product solidity, in functionality and to serve its intended purposes, to authenticate a fingerprint and prevent identity theft at this point transactions are completed, 1Q, 1R, 1S, in this order, began shutting down, resetting database and preparing wrap up, cancelling all information and clearing all registers etc., and placing the database system in a stand-by mode, to await next request from the mating FIG. 1, fingerprint detector, for, authentication, of an incoming fingerprint, at which time the database system will once again run its repetitive program in order of operations and deliver an answer to the sending fingerprint retrieval system, advising

a merchant to either accept or void a transaction, as the loopback answer leaves output node the point of origination, FIG. 1, whereas 1T is the coded data output node for the transmission back to FIG. 1, all referenced components are housed and mounted in FIG. 1H located in present invention in direct communication mating coding translation housing interacting present invention housing, Thereof,

### FIGURE DRAWING EXPLANATION

FIG. 1 is a perspective view of a fingerprint operable soft and hardware programmed computer hereafter (CPU) system having interfaced communication transmission means, storages Distinguishable marked buttons, along with database example buttons direct tie buttons, serial ports, USB connection, along with printer and input, all located on front housing of present invention housing, thereof.

FIG. 1A is showing the fingerprint circuit out its housing, and when configured in its disk housing 1B, and seated in the disk housing 1C is the start means to FIG. 1, 1C is located on present invention housing thereof

FIG. 2 is an enlarged portion of present invention, showing fingerprint Retrievals Disk housing, the housing affords a hardtop or a removable Len, the fingerprint carrying housing, is Illustrating an insertion point, start-up means to CPU, having A mating configured circuit provides excitation when disk is inserted into Fingerprint disk housing, changes systems state to output signal, which inputs a Signal start means to CPU's order of operational programs, the fingerprint disk Housing is located on the right side center housing, of present invention, thereof, For troubleshooting etc., the manual operating power switch is represented by a (1),/(0) the manual switch is located on lower left bottom, right side, of Present invention housing, thereof.

FIG. 3 is a bottom view of the electronic fingerprint detector retrieval housing Viewing locations of a variety of embedded components, troubleshooting means Utilize an access code, whereby inputting the access code, on front housing Peripheral, the bookkeeping housing compartment will automatically open, the Incorporated bookkeeping chip provides owners more monetary control insofar As taxes, and pertinent data issues requested by Government, a customer or a Financial institution needing proof of transaction, and date,

Additionally shown is service entrance for disk housing, peripheral connector, USB Power in, peripheral connector, communications/modem insert and an additional slot held In reserved service for an unforeseen device needed in the later, along with manual On/off switch, for trouble shooting manually, the said bookkeeping chip housing, disk Insert housing, input/output peripheral connector, USB power input, Communication/modem card insert housing, manual on/off switch housings are Distinguishale marked, and located on bottom of present invention housing, thereof

FIG. 4. Is a back elevated view of the top of the fingerprint retrieval unit showing the VAC plug, is polarity to fingerprint retrieval unit, the VAC plug is located on the Lower right side, top of present invention housing, thereof,

Additionally shown is the input telephone connections housing, means of Connecting a telephone to the fingerprint retrieval unit, the telephone connection Housing is located on the lower left side, top of present invention housing, thereof,

The fingerprint significant minute points will be Value, and further, each minute point generating a signal in numerical value, Where by each value generates a definite signal output value, in final said Fingerprint minute points are a series of computer pulsating signals, these signals Are now output has been created, and said output signals are coded, input Signals/pulses to a modem or the like device, where a conversion from computer Language is transformed into suitable transmission tones over a network or Communication facility utilizing audio pulse tones for travel or other transmission Intelligence, the fingerprint travels over the wires/network in the form of the said Audio pulse tones or other transmission intelligence, to its mating interacting Fingerprint database, as the transmitted fingerprint enters the fingerprint database Housing, it passes through a companion modem or like device, the audio pulse CPU micro-board, with all supporting elements, to insure operational Tones or similar transmission Intelligence device, is changed back into its original format Understandable by a computer language to properly interact in conversation with the Companion fingerprint database system's computer, as the fingerprint exits out the Modem, the first bit out is the start means Of the CPU's sequential order of operations, the sent fingerprint continues inside the Fingerprint database system to its destination of a holding mode housing Holding mode housing, (hereafter called holding housing) provided in the fingerprint Once completely loaded into the holding circuit housing, its completion, creates a Stimulus, start means of the database's CPU to execute a search program for the seated Fingerprint, further, the CPU executes commanding statements sending a set of signals in Op code signifying completion using a loop back configuration of completion, thereby, Fingerprint once the fingerprint is identified in the database, the compiled CPU's order Of operations will further queue all data associated with the identified matching Directing the system to loopback signal to the source point, (the fingerprint retrieval unit) An answer back indicating acknowledgement answer to the original query at this stage of Operations, the information gathered passes back through the interactive conversational Database's modem or similar type communication device, again coded, and converted Into audio pulse tones or other transmission intelligence suitable for travel back to the Interacting fingerprint retrieval unit entering into the fingerprint units companion Modem or like device, converted back into understandable computer language logic, That the fingerprint retrieval unit modem or cellular device, converting the coded pulse Signals, back in computer language to the CPU whereby, the CPU issues a commanding Read/print statement to the “fingerprint retrieval's digital print out screen the answer to Its query in format readable to the human eye, thereby, alerting the sending institution or Business to either VOID or ACCEPT transaction. Meanwhile the output from the Interacting conversational database CPU continues its closing statements, signaling Release of the original fingerprint from the holding circuit housing, clearing the cache, all Registers along with all data associated with that particular sent fingerprint and switches The database off to a standby position, awaiting another fingerprints entrance, at which Time the database will once again do all of the aforementioned order of operations in its Repetitive preprogrammed cycles.

It should be noted while these products are designed with financial institutions in mind

Where positive identification is a must or otherwise FRUAD, such as checks, credit Cards, passbooks, ATM machines, revolving charge accounts, and safety deposit Boxes Carry valuables and other forms of valuables, it should be understood that present Invention is not limited to one application of protection alone, other markets and Industries would profit by utilizing this product. One of the chief advantage is Sizing, and secondly the designed with the ability to interface, and or converse with Existing equipment.

To mention a few, employee time clocks, high priority lavatories, Law enforcement in Interacting fingerprint retrieval unit entering into the fingerprint units companion Modem or like device, converted back into understandable computer language logic, That the fingerprint retrieval unit modem or cellular device, converting the coded pulse Signals, back in computer language to the CPU whereby, the CPU issues a commanding Read/print statement to the “fingerprint retrieval's digital print out screen the answer to Its query in format readable to the human eye, thereby, alerting the sending institution or Business to either VOID or ACCEPT transaction. Meanwhile the output from the Interacting conversational database CPU continues its closing statements, signaling Release of the original fingerprint from the holding circuit housing, clearing the cache, all Registers along with all data associated with that particular sent fingerprint and switches The database off to a standby position, awaiting another fingerprints entrance, at which Time the database will once again do all of the aforementioned order of operations in its Repetitive preprogrammed cycles.

It should be noted while these products are designed with financial institutions in mind Where positive identification is a must or otherwise FRUAD, such as checks, credit Cards, passbooks, ATM machines, revolving charge accounts, and safety deposit Boxes Carry valuables and other forms of valuables, it should be understood that present Invention is not limited to one application of protection alone, other markets and Industries would profit by utilizing this product. One of the chief advantage is Sizing, and secondly the designed with the ability to interface, and or converse with Existing equipment.

To mention a few, employee time clocks, high priority lavatories, Law enforcement in FIG. 5 is an enlarged portion of FIG. 1 lower front housing showing in detail the inputs to present, these inputs design of FIG. 1 is for additions and or for additions other peripherals enhancements these input housing are located on lower housing, of present invention housing thereof

FIG. 6 is a software program template, to serve as a guideline the way the system works, FIG. 6 is self explanatory, insofar as steps in sequential order of operations, along with showing the switching mode of fingerprint detection to manual transactions is another keen feature of the marvelous invention being introduced here

Having thus described the invention, what is claimed:

1. An individual electronic FINGERPRINT operable micro COMPUTER retrieval system and fingerprint capturing disk, that captures, codes and loads an output fingerprint transmission via incorporated communication means to input its mating conversational interacting comparison database system, or the likes, that selectively authenticates an individuals true identification, using one database pre-logged fingerprint, access in a particular database when an individual/consumer inputs that chosen pre-logged fingerprint in the present inventions fingerprint retrieval housing, including:
a housing, a CPU, which operates the fingerprint detector according to a program of operations, stores data indicative to the fingerprint detector, all supporting elements in private housing, a compiled programmed fingerprint capture, coding, load output micro disk, and private disk housing,
with start means to CPU housed in fingerprint retrieval housing system unit
a private reader, display and digital print screen housing,
a plurality of alpha/numerical key pad housing, a plurality of private database functional keys distinguishably marked (master card, visa or Saks Fifth Ave., etc.,) for database direct network connection means

2. The electronic FINGERPRINT operable micro COMPUTER retrieval system and fingerprint capturing disk, of claim 1. including a conditional mating interacting Fingerprint Comparison Verification Network System unit database so designed
a mating interacting fingerprint operable, comparison/verification in latest technology and has customized micro motherboard, with all supporting elements and programmed means incorporated in an individual sub-assemble private housing, in present invention
a private micro fingerprint carrying electronic disk type apparatus having means to
a mating comparison verication database system, that adheres a strict protocol in processing an individuals fingerprint utilizing an individuals input fingerprint, outputting said fingerprint as a direct input to its mating comparison, verification prelogged fingerprint in a particular database, that will allow retrieval, comparing, according to a program of automated, operations in artificial intelligence, and having means to stores data indicative to the user of the fingerprint detector, having compiled programmed, and all supporting elements in a sub-assembled private housing, located @ database system that captures, fingerprint, image, performs coding, loads, and locks an output with start means to CPU housed in fingerprint retrieval housing system unit
a private digital reader, that can be seen clearly by the naked eye, in digital print digital display screen housing
a plurality of alpha/numerical key pad housing, a plurality of private database functional keys distinguishably marked (master card, visa or Saks Fifth Ave., etc.,) for database direct network connection means

2. The electronic FINGERPRINT operable micro COMPUTER retrieval system and fingerprint capturing disk, of claim 1 including a conditional mating interacting Fingerprint Comparison Verification Network System unit database so designed To function as a private design, plug N play/harness conversions databases that performs a comparison of any output fingerprint from the “fingerprint retrieval system unit it's mating interacting fingerprint detector interacting database comparison verification system unit, with a plurality of hold circuits that hold input print, and the match when found until the cycle has completed the fetch data signal that activates a final statement and loads the answer in a loop back format programmed depending on the fingerprint findings, will additionally perform a digital print out in the digital screen print out either Accept or Void a transaction directly from the database comparison verification systems:

3. The electronic FINGERPRINT operable micro COMPUTER retrieval system and fingerprint capturing disk, of claim 1. including a private, CPU, that operates and functions according to a compiler program of operations, with all supporting elements incorporated in the Fingerprint detector retrieval system unit to match and identify a sent fingerprint transmitted from the fingerprint operable micro Detector retrieving system to a direct input to its mating database comparison verification system, hold housing, when seated excites the CPU, of programs to activates a search, compare statement, if comparison is made lock N hold the retrieved fingerprint, fetch corresponding data associated with the transmitted fingerprint

4. The electronic FINGERPRINT operable micro COMPUTER retrieval system And fingerprint capturing disk, of claim 1 including a plurality of private hold mode inner housing, of FIG. 1h database verification system unit, programmed to go to a fetch mode do a fingerprint comparison, followed by a decision, if true go to get additional data, if data requested is a match go to signal ACCEPT path if not load output as a VOID forwarded an answer, via loop reply, signaling output back to sending Fingerprint detector retrieval system, digital print screen housing, format that human can read to either accept or void the transaction

5. The electronic FINGERPRINT operable micro COMPUTER retrieval system and fingerprint capturing disk, of claim 1. a micro computer controlled fingerprint retrieval unit housing, incorporating a private fingerprint carrying disk, where insertion over or in fingerprint disk generates an output signal that activates a start means to inner housed CPU in the fingerprint retrieval system unit compiled programs of operations

6. The electronic FINGERPRINT operable micro COMPUTER retrieval system And fingerprint capturing disk, of claim 1 a private plurality of programs in algorithms and/protocols incorporated in fingerprint carrying disk housing, retrieval housing, database housing, including a coordinate axis lens, start, search rotate sample matched fingerprint, and find compare, activate fetch data when a fingerprint is a match, verify funds data request cycle completed, load, lock and output results loop back to the fingerprint detector retrieval system results of the original sent fingerprint

7. The electronic FINGERPRINT operable micro COMPUTER retrieval system And fingerprint capturing disk, of claim 1. having a private digital from interacting comparison database networking system, in a digital display screen, a reception housing means, for loop-back final answer format, readable language of owner's choice, “security alert” in silent mode of operation or play a note from jail house rock, owners choice, if answer is to ABORT however, if answer is to ACCEPT, complete the transaction for the individual using your service is true, has been authenticated

8. The electronic FINGERPRINT operable micro COMPUTER retrieval system And fingerprint capturing disk, of claim 1. private fingerprint transaction program procedure template, distinguishably marked functions of the program after a fingerprint has been inserted in a retrieval unit system, showing interaction with its mating comparison database functionality, from start to end transaction/in a Block diagram form, also shown is
a detailed typed page explanation of the programmed template
a private procedure/unit housing,
a CPU private inner housing, display screen, a reception housing means, for loop-back final answer
a private logic processing section control housing
a top housing for ac and networking plug-ins

9. The electronic FINGERPRINT operable micro COMPUTER retrieval system and fingerprint capturing disk, of claim 1. private communication/modem, and wireless housing,
a private accounting bubble memory storage chip housing, with private PC retrieval
a private plurality of reserved tie trunk lines for direct database networking connection/conversation housing
a private peripheral input/output connection housing,
a private power jack housing,
a private AC housing

9. The electronic FINGERPRINT operable micro COMPUTER retrieval system And fingerprint capturing disk, of claim 1. a written fingerprint start transactions basic function explanation, showing a basic functional initiation works for processing a financial institute transaction, this
for such applications as door locks, automobile ignitions, safe deposit boxes, example written out is a basic and most common usage of the invention, entrance and or the likes, or the United States Government, and its personnel however, it should be understood, that this micro invention, can be edited down as small as a Pico sized system unit, (p) or
furthermore can additionally be stepped up to provide a larger and or different database bank for a conglomerate multi set of prints involving national security
